(19) United States
(12) Patent Application Publication
(10) Pub. No.: US 2012/0253693 A1
(43) Pub. Date: Oct. 4, 2012

(54) SAMPLE ANALYZER

(75) Inventors: Norikazu INOMATA, Kobe-shi (JP); Daiki KARINO, Kobe-shi (JP)

(73) Assignee: SYSMEX CORPORATION, Kobe-shi (JP)

(21) Appl. No.: 13/434,123

(22) Filed: Mar. 29, 2012

(30) Foreign Application Priority Data
Mar. 30, 2011 (JP) 2011-076083

(51) Int. Cl. G06F 17/40

(52) U.S. Cl. 702/31; 702/187

(57) ABSTRACT

The present invention is a sample analyzer, comprising: an analyzing section for analyzing a sample; a memory for storing analysis results of the sample by the analyzing section and an event history information indicating an event that occurred in the sample analyzer; an input device used to specify an analysis result from a plurality of analysis results stored in the memory; a display; and a controller for acquiring an event history information related to the analysis result specified by the input device from the memory and controlling the display to show information related to a cause of uncertainty of the specified analysis result based on the acquired event history information.

### FIELD OF THE INVENTION

The present invention relates to a sample analyzer for analyzing samples such as blood and urine.

### BACKGROUND

Conventionally, for example, U.S. Patent Application Publication No. 2009/202390 discloses an automatic analyzer for displaying information of an analyzing process executed in the past sample analysis. In such automatic analyzer, the information of a plurality of analyzing processes is displayed in association with the performed time on the same time axis. The information on the used facility and the consumable goods are also displayed with the information of the analyzing process.

Furthermore, in the automatic analyzer disclosed in U.S. Patent Application Publication No. 2009/202390, the used reagent, the standard curve information used for the concentration calculation of the analysis result, and the detailed information of the sample analysis performed to derive the standard curve are displayed when the information of the analyzing process indicating the dispension of the reagent is double clicked.

The analysis result of such sample analyzer has uncertainty, where the reliability of the analysis result may lower the greater the uncertainty. Thus, it is important to specify the cause of uncertainty in the sample analyzer. In the automatic analyzer described in U.S. Patent Application Publication No. 2009/202390, however, the information on the facility and the consumable goods used for the sample analysis as well as the information on the used reagent and the standard curve are displayed, but which one of the displayed information corresponds to the cause of uncertainty and which one of the information does not correspond to the cause of uncertainty are not indicated. Thus, the user cannot specify what the cause of uncertainty is.

### SUMMARY OF THE INVENTION

The scope of the present invention is defined solely by the appended claims, and is not affected to any degree by the statements within this summary.

A first aspect of the present invention is a sample analyzer, comprising: an analyzing section for analyzing a sample; a memory for storing analysis results of the sample by the analyzing section and an event history information indicating an event that occurred in the sample analyzer; an input device used to specify an analysis result from a plurality of analysis results stored in the memory; a display; and a controller for acquiring an event history information related to the analysis result specified by the input device from the memory and controlling the display to show information related to a cause of uncertainty of the specified analysis result based on the acquired event history information.

A second aspect of the present invention is a non-transitory storage medium which stores computer-executable programs executed by at least one processor of a sample analyzer to: store an analysis result obtained by the sample analyzer in a memory; store an event history information indicating an event that occurred in the sample analyzer in the memory; acquire from the memory an event history information related to an analysis result specified by an input device of the analysis results from a plurality of analysis results stored in the memory and control a display to show information related to a cause of uncertainty of the specified analysis result based on the acquired event history information.

A third aspect of the present invention is a sample analyzer, comprising: an analyzing section for analyzing a sample; an input device used to specify an analysis result from a plurality of analysis results obtained by the analyzing section; a display; and a controller connected to a memory, wherein the memory stores an analysis result of the sample by the analyzing section and stores an event history information indicating an event that occurred in the sample analyzer; and the controller acquires from the memory an event history information related to the analysis result specified by the input device and controls the display to show information related to a cause of uncertainty of the analysis result based on the acquired event history information.

### BRIEF DESCRIPTION OF THE DRAWINGS

FIG. 1 is a perspective view showing a configuration of a sample analyzer according to an embodiment;

FIG. 2 is a plan view showing a schematic configuration of a measuring device of the sample analyzer according to the embodiment;

FIG. 3 is a side view showing a configuration of a first reagent dispensing unit shown in FIG. 2;

FIG. 4 is a block diagram showing a circuit configuration of a measuring device;

FIG. 5 is a block diagram showing a configuration of an information processing device of the sample analyzer according to the embodiment;

FIG. 6 is a schematic view showing a configuration of a database arranged in a hard disc of the information processing device;

FIG. 7 is a flowchart showing a flow of uncertainty cause displaying process by an information processing device according to the embodiment;

FIG. 8 is a view showing one example of an analysis result screen; and

FIG. 9 is a view showing one example of an uncertainty cause screen.

### DETAILED DESCRIPTION OF THE PREFERRED EMBODIMENTS

The preferred embodiments of the present invention will be described hereinafter with reference to the drawings.

### [Configuration of Sample Analyzer]

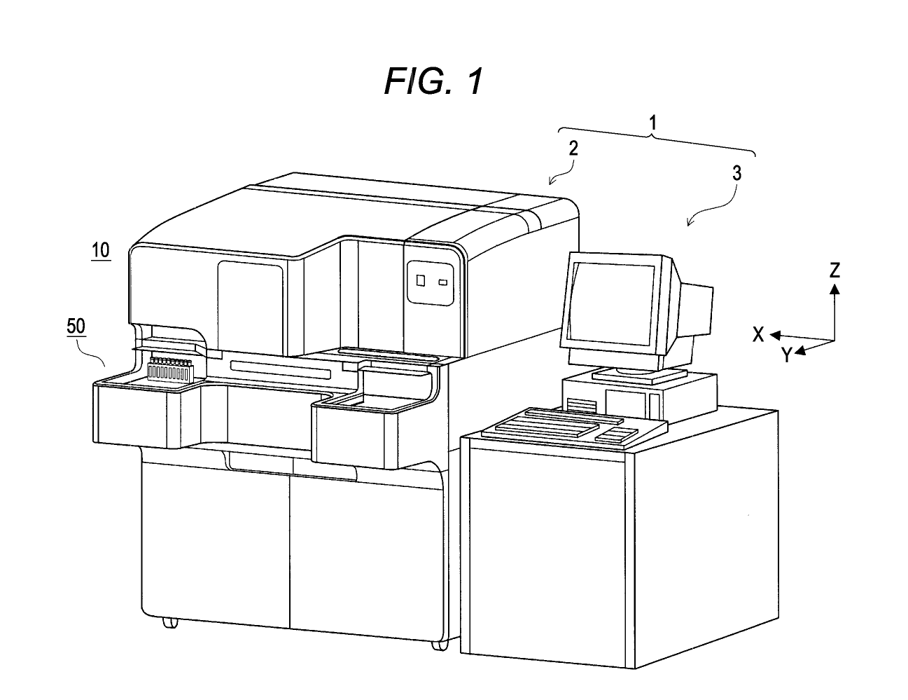

FIG. 1 is a perspective view showing a configuration of a sample analyzer 1 according to the present embodiment. The sample analyzer 1 is configured to include a measuring device 2 for optically measuring components contained in a sample (blood), and an information processing device 3 for processing the measurement data from the measuring device 2 to obtain an analysis result of the sample and giving an operation instruction to the measuring device 2.

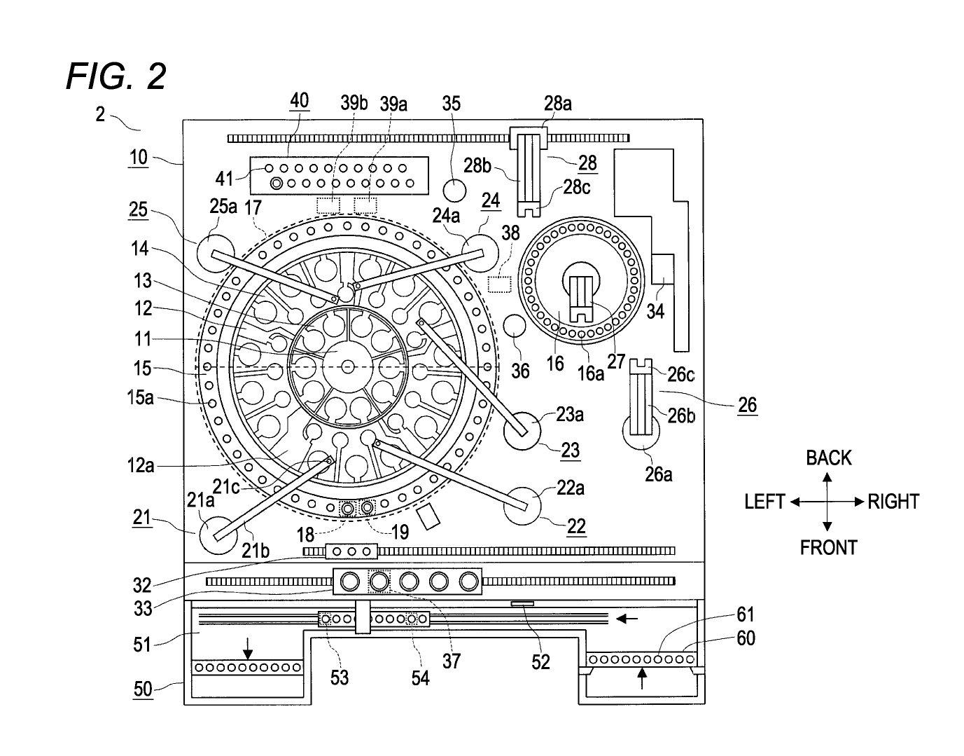

FIG. 2 is a plan view showing a schematic configuration of the measuring device 2. The measuring device 2 is configured by a measurement unit 10, a detection unit 40, and a transportation unit 50.

The measurement unit 10 includes a first reagent table 11, a second reagent table 12, a first container rack 13, a second container rack 14, a cuvette table 15, a warming table 16, a table cover 17, a first sample dispensing unit 21, a second sample dispensing unit 22, a first reagent dispensing unit 23, a second reagent dispensing unit 24, a third reagent dispensing unit 25, a first catcher unit 26, a second catcher unit 27, a third catcher unit 28, a cuvette transport unit 32, a diluted solution transport unit 33, a cuvette port 34, and discarding ports 35, 36.

The first reagent table 11, the second reagent table 12, the cuvette table 15, and the warming table 16 are circular tables, and are each adapted to be rotationally driven independently to both directions, clockwise direction and counterclockwise direction. The rotational drive of such tables is carried out by a plurality of stepping motors (not shown) arranged on the back side.

Five first container racks 13 and five second container racks 14 are removable arranged, as shown in the figure, on the upper surfaces of the first reagent table 11 and the second reagent table 12, respectively. The first container rack 13 and the second container rack 14 are formed with a holder for holding a reagent container.

In the sample analyzer 1, sample analysis is carried out for a plurality of analyzing items. The reagent of a type corresponding to the analyzing item is set in the first reagent table 11 and the second reagent table 12. The reagent is set with an expiration date, where the reagent is replaced by the user when there is no remaining amount or when the expiration date is past. The information on the type and holding position of each reagent held in the first reagent table 11 and the second reagent table 12 is stored in a hard disc 304 arranged in a control section 300 of the measuring device 2, to be described later. Thus, when measuring the sample, at which holding position the reagent to be used for the measurement of the sample is arranged can be specified.

The cuvette table 15 and the warming table 16 respectively includes a plurality of cuvette holding holes 15a, 16a along the circumference, as shown in the figure. When the cuvette is set in the cuvette holding hole 15a, 16a, such cuvette moves along the circumference position in accordance with the rotation of the cuvette table 15 and the warming table 16. Furthermore, the warming table 16 warms the cuvette set in the holding hole 16a at a predetermined temperature.

The table cover 17 is arranged to cover the upper surfaces of the first reagent table 11, the second reagent table 12, and the cuvette table 15. Such table cover 17 can be opened when replacing the reagent. The table cover 17 has a plurality of holes (not shown). The first sample dispensing unit 21, the second sample dispensing unit 22, the first reagent dispensing unit 23, the second reagent dispensing unit 24, and the third reagent dispensing unit 25 dispense the reagent through such plurality of holes.

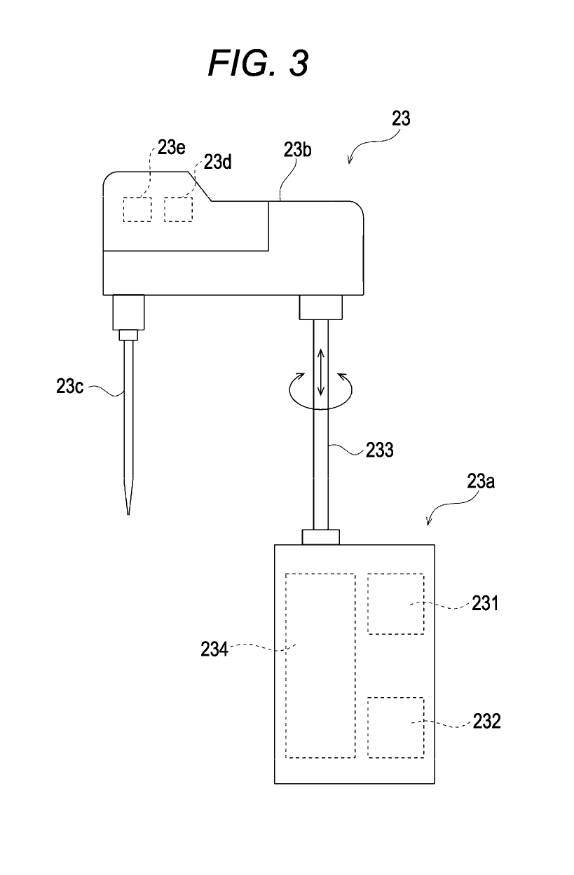

FIG. 3 is a side view showing a configuration of the first reagent dispensing unit 23. As shown in the figure, the first reagent dispensing unit 23 includes a driving portion 23a, an arm 23b, and a pipette 23c. The driving portion 23a includes a rotation motor 231, a raising/lowering motor 232, and a transmission mechanism 234 for transmitting the power of the rotation motor 231 and the raising/lowering motor 232 to a shaft 233. The transmission mechanism 234 is configured by a belt transmission mechanism or a gear mechanism for decelerating the rotation power of the rotation motor 231 and transmitting the same to the shaft 233, a belt transmission mechanism or a rack-pinion mechanism for converting the rotation power of the raising/lowering motor 232 to a linear power in the up and down direction and transmitting the same to the shaft 233.

The rotating direction and the rotation amount of the rotation motor 231 are detected by a rotary encoder 235, and the rotating direction and the rotation amount of the raising/lowering motor 232 (i.e., up and down moving direction and movement amount of pipette 23c) are detected by a rotary encoder 236.

A contact-type capacitance sensor 23d for detecting that the distal end of the pipette 23c is in contact with a liquid level is connected to the pipette 23c of the first reagent dispensing unit 23. When aspirating the sample with the pipette 23c, the pipette 23c is lowered to make contact with the liquid level of the sample, and the detection signal thereof is output from the capacitance sensor 23d.

The arm 23b includes an optical sensor 23e for abnormality detection of the pipette 23c. When the distal end (lower end) makes contact with an obstacle while being lowered, the pipette 23c can move relatively to the upper side with respect to the arm 23b. The optical sensor 23e includes a light emitting element and a light receiving element, where the light emitted from the light emitting element is normally received by the light receiving element but the light from the light emitting element is shielded so that the light receiving element does not receive the light when the pipette 23c is raised with respect to the arm 23b. Thus, the optical sensor 23e can detect that the pipette 23c made contact with the obstacle by the change in the light receiving level of the light receiving element of the optical sensor 23e.

The configurations of the first sample dispensing unit 21, the second sample dispensing unit 22, the second reagent dispensing unit 24, and the third reagent dispensing unit 25 are similar to the configuration of the first reagent dispensing unit 23, and thus the description thereof will be omitted.

The respective pipette of the first sample dispensing unit 21, the second sample dispensing unit 22, the first reagent dispensing unit 23, the second reagent dispensing unit 24, and the third reagent dispensing unit 25 is replaceable. The pipette is replaced by a service man when the used number of times (dispensed number of times) of the pipette becomes greater than or equal to a predetermined number.

Returning back to FIG. 2, the first catcher unit 26 is configured by a supporting portion 26a for supporting an arm 26b, a stretchable arm 26b, and a gripping portion 26c. The supporting portion 26a is rotatably driven by a stepping motor (not shown) arranged on the back side of the lower surface. The gripping portion 26c is attached to the distal end of the arm 26b so as to be able to grip the cuvette. The second catcher unit 27 has a configuration similar to the first catcher unit 26, and is rotated by a stepping motor (not shown).

The third catcher unit 28 is configured by a supporting portion 28a for supporting an arm 28b, a stretchable arm 28b, and a gripping portion 28c attached to the distal end of the arm 28b, as shown in the figure. The supporting portion 28a is driven along a rail arranged in the left and right direction. The gripping portion 28c can grip the cuvette.

The cuvette transport unit 32 and the diluted solution transport unit 33 are driven on the rail in the left and right direction. The cuvette transport unit 32 and the diluted solution transport unit 33 each includes a hole for holding the cuvette and the diluted solution container, respectively.

A new cuvette is constantly supplied to the cuvette port 34. The new cuvette is set in the hole for holding the cuvette in the cuvette transport unit 32 and the cuvette holding hole 15a of the cuvette table 15 by the first catcher unit 26 and the second catcher unit 27. The discarding ports 35, 36 are holes for discarding the cuvettes, which analysis is finished and which became unnecessary.

The detection unit 40 includes twenty holding holes 41 for accommodating the cuvette at the upper surface, where a detector (not shown) is arranged on the back side. When the cuvette is set in the holding hole 41, the optical information is detected from a measurement sample in the cuvette by the detector.

The transportation unit 50 includes a transportation path 51. The bottom surface of the transportation path 51 includes a pre-analysis rack holding region on the right side, a transportation region at the middle, and a post-analysis rack holding region on the left side, and is formed to a U-shape. A sample barcode reader 52 reads the barcode of the barcode label attached to a sample container 61 accommodated in a sample rack 60 transported through the transportation region.

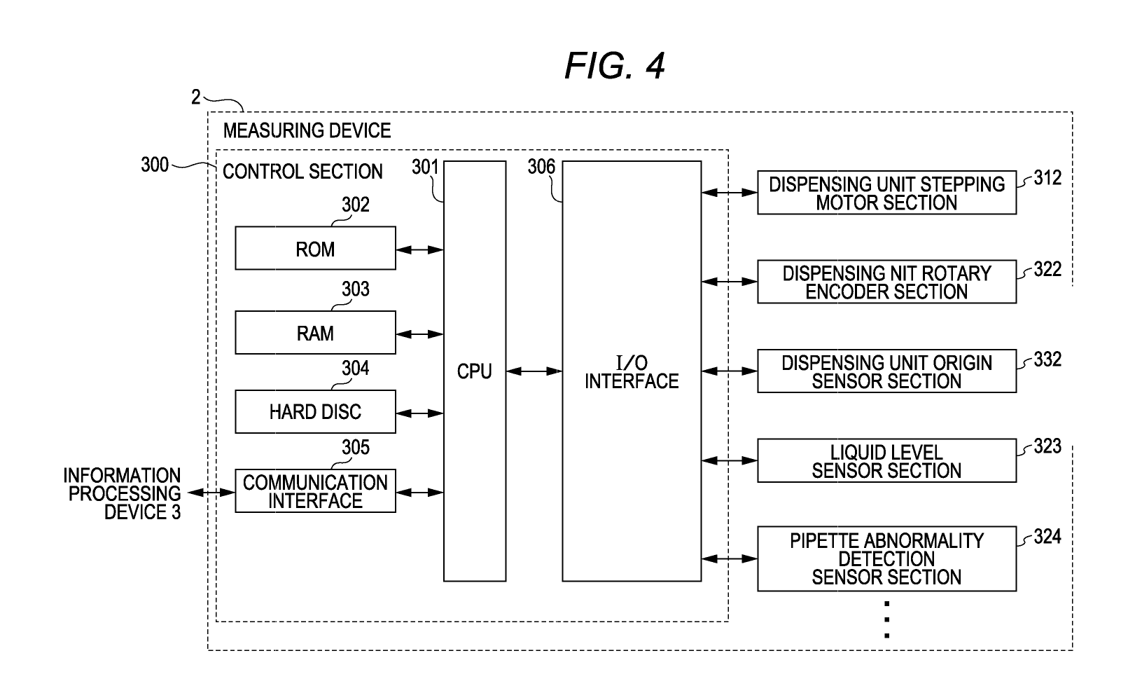

FIG. 4 is a block diagram showing a circuit configuration of the measuring device 2.

The measuring device 2 includes a control section 300, a dispensing unit stepping motor section 312, a dispensing unit rotary encoder section 322, a liquid level sensor section 323, and a pipette abnormality detection sensor section 324. The control section 300 includes a CPU 301, a ROM 302, a RAM 303, a hard disc 304, a communication interface 305, and an I/O interface 306.

The CPU 301 can execute computer programs stored in the ROM 302 and the computer programs loaded in the RAM 303. The RAM 303 is used to read out the computer programs recorded on the ROM 302 and the hard disc 304. When executing such computer programs, the RAM 303 is also used as a work region of the CPU 301. In the hard disc 304, installed are various computer programs to be executed by the CPU 301 such as operating system and application program, as well as data used in executing the computer program. That is, a control program for causing the CPU 301 to control each section of the measuring device 2 is installed in the hard disc 404. The data can be transmitted to and received from the information processing device 3 by the communication interface 305.

The CPU 301 is connected to the dispensing unit stepping motor section 312, the dispensing unit rotary encoder section 322, a dispensing unit origin sensor section 332, the liquid level sensor section 323, and the pipette abnormality detection sensor section 324 through the I/O interface.

The dispensing unit stepping motor section 312 is configured by a rotation motor 231 and a raising/lowering motor 232 of the first reagent dispensing unit 23, as well as a rotation motor and a raising/lowering motor for each of the first sample dispensing unit 21, the second sample dispensing unit 22, the second reagent dispensing unit 24, and the third reagent dispensing unit 25. Such rotation motors and raising/lowering motors are stepping motors.

The dispensing unit rotary encoder section 322 is configured by rotary encoders 235, 236 of the first reagent dispensing unit 23, as well as a rotary encoder for each of the first sample dispensing unit 21, the second sample dispensing unit 22, the second reagent dispensing unit 24, and the third reagent dispensing unit 25. That is, the dispensing unit rotary encoder section 322 is configured by a plurality of rotary encoders capable of detecting the rotating direction and the rotation amount of a plurality of stepping motors arranged in the dispensing unit stepping motor section 312, respectively. The dispensing unit origin sensor section 332 is configured by a plurality of origin sensors for detecting that the rotation position of a plurality of stepping motors arranged in the dispensing unit stepping motor section 312 is at an origin position, respectively. When receiving an output signal of the relevant dispensing unit rotary encoder section 322 and the dispensing unit origin sensor section 332, the CPU 301 can recognize how many times the respective arms 21a, 22a, 23a, 24a, 25a of the first sample dispensing unit 21, the second sample dispensing unit 22, the first reagent dispensing unit 23, the second reagent dispensing unit 24, and the third reagent dispensing unit 25 turned in the clockwise direction or the counterclockwise direction from the origin position in the rotating direction and to what extent the respective arms moved upward or downward from the origin position (reference height) in the height direction.

The liquid level sensor section 323 is configured by a capacitance sensor 23d of the first reagent dispensing unit 23, as well as a capacitance sensor of each of the first sample dispensing unit 21, the second sample dispensing unit 22, the second reagent dispensing unit 24, and the third reagent dispensing unit 25. When receiving an output signal of the relevant liquid level sensor section 323, the CPU 301 can recognize whether or not the respective pipettes 21c, 22c, 23c, 24c, 25c of the first sample dispensing unit 21, the second sample dispensing unit 22, the first reagent dispensing unit 23, the second reagent dispensing unit 24, and the third reagent dispensing unit 25 are brought into contact with the liquid level.

The pipette abnormality detection sensor section 324 is configured by an optical sensor 23e of the first reagent dispensing unit 23, and an optical sensor of each of the first sample dispensing unit 21, the second sample dispensing unit 22, the second reagent dispensing unit 24, and the third reagent dispensing unit 25. When receiving an output signal of the relevant pipette abnormality detection sensor section 324, the CPU 301 can recognize the respective abnormality of the pipettes 21c, 22c, 23c, 24c, 25c of the first sample dispensing unit 21, the second sample dispensing unit 22, the first reagent dispensing unit 23, the second reagent dispensing unit 24, and the third reagent dispensing unit 25.

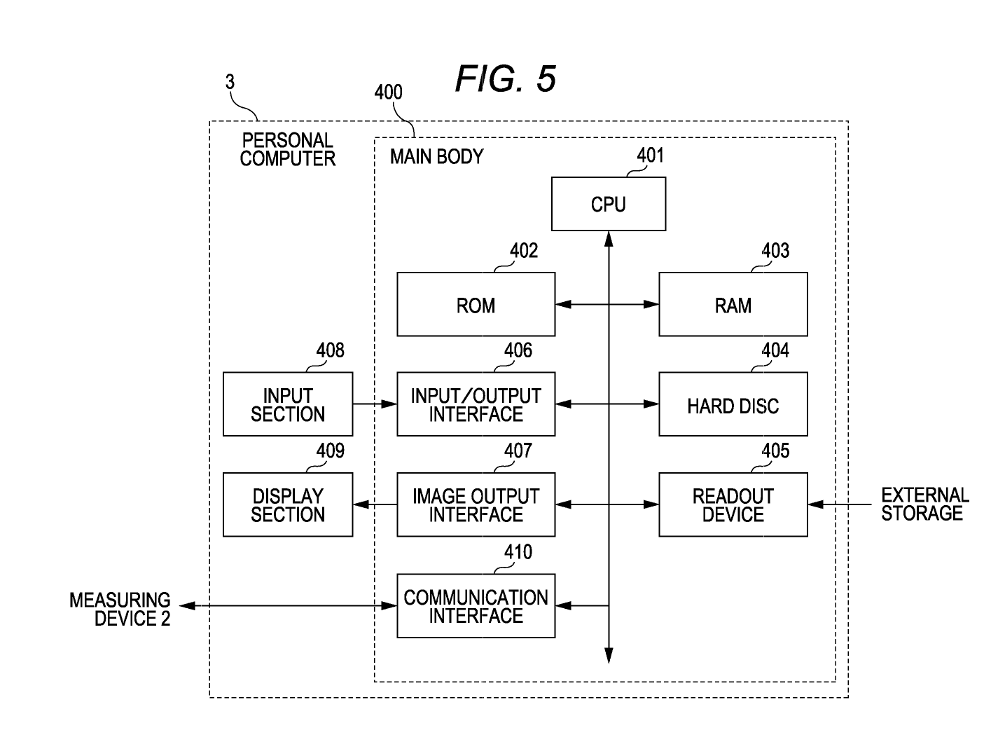

FIG. 5 is a block diagram showing a configuration of the information processing device 3.

The information processing device 3 includes a personal computer, and is configured by a main body 400, an input section 408, and a display section 409. The main body 400 includes a CPU 401, a ROM 402, a RAM 403, a hard disc 404, a readout device 405, an input/output interface 406, an image output interface 407, and a communication interface 410.

The CPU 401 can execute computer programs stored in the ROM 402 and the computer programs loaded in the RAM 402. The RAM 403 is used to read out the computer programs recorded on the ROM 402 and the hard disc 404. When executing such computer programs, the RAM 403 is also used as a work region of the CPU 401.

In the hard disc 404, installed are various computer programs to be executed by the CPU 401 such as operating system and application program, as well as data used in executing the computer program. That is, in the relevant hard disc 404, installed are computer programs for causing the computer to function as the information processing device according to the present embodiment.

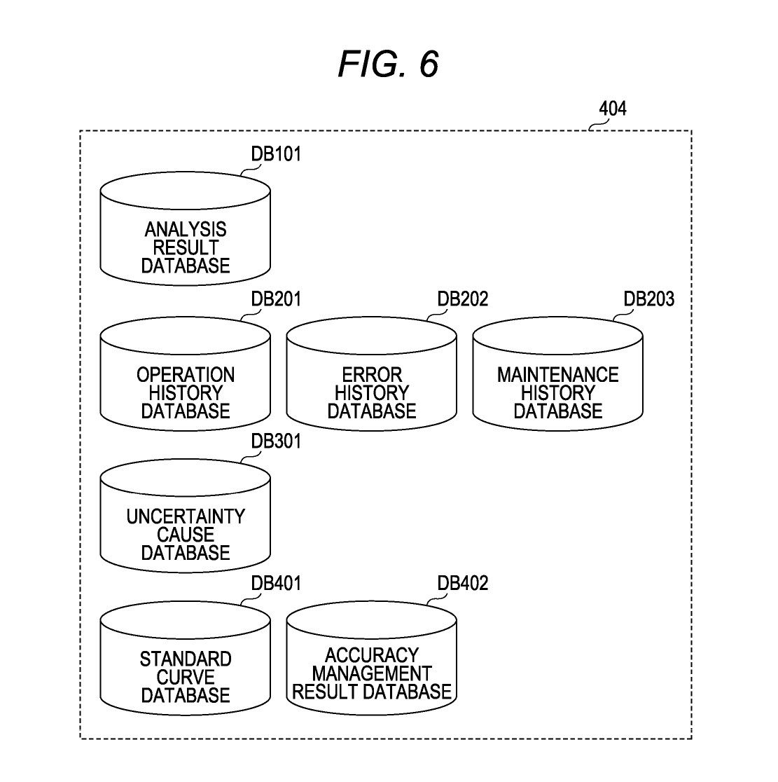

FIG. 6 is a schematic view showing a configuration of a database arranged in a hard disc 404. The hard disc 404 includes an analysis result database DB101 that stores the sample analysis results, an operation history database DB201, an error history database DB202, a maintenance history database DB203, an uncertainty cause database DB301, a standard curve database DB401 that stores information related to a standard curve, and an accuracy management result database DB402 that stores the accuracy management results.

The analysis result database DB101 stores, for every sample, records such as sample ID, analyzed date and time (e.g., “2011/2/1 11:14”), analyzing item (e.g., “PT”), measurement data (e.g., “10.6”), abnormality information, and lot number of a reagent used in the measurement. The abnormality information is information indicating that the sample is abnormal, and such abnormality information is generated when the measurement data deviates from a reference range. If the measurement data is within the reference range, the abnormality information is not stored in the analysis result database DB101.

The operation history database DB201 stores, for every operation, records such as user name (e.g., “operator A”) of a user who performed the operation, date and time at which the operation was performed (e.g., “2011/2/1 10:34”), and type of operation (e.g., “log on”). The error history database DB202 stores, for every error that occurs, records such as user name (e.g., “operator A”) of a user who is logged in at the time of error occurrence, date and time at which the error occurred (e.g., “2011/2/1 11:12”), and type of error (e.g., “pipette crash”). The “pipette crash” is an abnormality in which the dispensing operation cannot be normally carried out since the pipette of the dispensing unit is brought into contact with an obstacle. The maintenance history database DB203 stores records such as user name “e.g., “user C”) who performed the maintenance, date and time at which the maintenance is performed (e.g., 2011/1/25 15:29), and type of maintenance (e.g., “pipette replacement”).

The uncertainty cause database DB301 stores records including type of event (operation, error, and maintenance of user) that becomes the cause of uncertainty, and handling method for reducing the uncertainty.

The sample analyzer 1 can be used by a plurality of users, where the user needs to execute the operation of “log on” when using the sample analyzer 1. Some users may not be familiar with the operation of the sample analyzer 1, and this may affect the sample analysis result as the operation may not be carried out in the normal procedure when such user logs on. Therefore, the operation “log on” may be the cause of uncertainty.

When the reagent is replaced, the state of the reagent may different, the type may be different, the lot may be different, the expiration date of the reagent after the replacement may be passed between the reagent before the replacement and the reagent after the replacement. In such a case, the reagent replacement may affect the sample analysis result. Therefore, the operation “reagent replacement” may be the cause of uncertainty. The uncertainty cause database DB301 is registered with “check lot number of replaced reagent”, “check replaced reagent” and “check expiration date of replaced reagent” as a handling method for reducing the uncertainty due to the reagent replacement.

The standard curve is data for converting the measurement value (raw data) of the sample to an analysis value (e.g., concentration, activity, amount, etc.). Such standard curve is created for every lot of the reagent. An accurate analysis result may not be obtained by the standard curve if the procedure for creating the standard curve is inappropriate or the expiration date of the standard curve has passed. That is, the standard curve creation may affect the sample analysis result. Therefore, the operation “standard curve creation” may be the cause of uncertainty. The uncertainty cause database DB301 is registered with “check created standard curve”, “check specimen used for standard curve measurement” and “check expiration date of standard curve” as a handling method for reducing the uncertainty by the standard curve creation.

As described above, when the pipette makes contact with an obstacle, the pipette abnormality detection sensor section 324 detects such abnormality. A normal sample analysis is not carried out if such pipette abnormality (“pipette crash”) occurs. That is, the occurrence of “pipette crash” affects the sample analysis result. Therefore, the error “pipette crash” may be the cause of uncertainty. The uncertainty cause database DB301 is registered with “check if reagent container is correctly installed” and “check whether reagent is not lacking” as a handling method for reducing the uncertainty by the pipette crash.

The number of usages is limited in the pipette arranged in each of the first sample dispensing unit 21, the second sample dispensing unit 22, the first reagent dispensing unit 23, the second reagent dispensing unit 24, and the third reagent dispensing unit 25, and thus the pipettes need to be replaced when reaching a predetermined number of usages. Thus, in the sample analyzer 1, the number of usages of the pipette of each dispensing unit is counted, and when the number of usages of the pipette exceeds a predetermined value, a message indicating replacement error of the pipette is displayed and the information of the pipette replacement error is registered in the error history database DB202. When the number of usages exceeds the predetermined value, the sample or the reagent may not be normally dispensed and the sample analysis may not be normally carried out if the sample or the reagent is not normally dispensed. Therefore, the error “replacement timing of pipette” may be the cause of uncertainty. The uncertainty cause database DB301 is registered with “check that pipette is replaced”, and “check measurement result/accuracy management result of before and after replacement of pipette” as a handling method for reducing the uncertainty by the pipette replacement error.

The sample or the reagent may not be dispensed if the pipette replacement is not normally carried out. Therefore, the maintenance “replacement of pipette is carried out” may be the cause of uncertainty. The uncertainty cause database DB301 is registered with “check number of operations of pipette”, and “check measurement result/accuracy management result of before and after replacement of probe” as a handling method for reducing the uncertainty by the pipette replacement.

The pipette of each dispensing unit is cleaned after the dispensing operation. If the cleaning of the pipette is not normally carried out, contamination may occur when the dispensing operation is carried out to measure the next sample, and hence an accurate analysis result may not be obtained. Therefore, the maintenance “pipette is cleaned” may be the cause of uncertainty. The uncertainty cause database DB301 is registered with “check measurement result/accuracy management result of before and after pipette cleaning” as a handling method for reducing the uncertainty by the pipette cleaning.

The sample analyzer 1 needs to operate normally in order for the sample analysis to be normally carried out. Therefore, the accuracy management of the sample analyzer is carried out to check that the sample analyzer 1 is in a state capable of carrying out a normal sample analysis. In the accuracy management, a predetermined accuracy management substance is measured with the sample analyzer 1, where determination is made that the analysis result by the sample analyzer 1 has high reliability if the analysis result thereof (hereinafter referred to as “accuracy management result”) is within a predetermined range. Furthermore, if the accuracy management result is deviated from the predetermined range, error information related to an accuracy management error is registered in the error history database DB202 as the accuracy management error. When an accuracy management abnormality occurs, the subsequent sample analysis result will have low reliability, and hence the error “accuracy management abnormality” may become the cause of uncertainty. The uncertainty cause database DB301 is registered with “check accuracy management substance/reagent used in measurement” and “check expiration date of accuracy management substance/reagent used in measurement” as a handling method for reducing the uncertainty by the accuracy management abnormality.

Returning back to FIG. 5, a configuration of the information processing device 3 will be continuously described. The readout device 405 is configured by a CD drive, a DVD drive, or the like, and can read out computer programs and data recorded on the recording medium. The input/output interface 406 is connected with the input section 408 including a mouse and a keyboard, so that the user can use the input section 408 to input data to the information processing device 3. The image output interface 407 is connected to the display section 409 configured by CRT, liquid crystal panel, or the like, and outputs an image signal corresponding to the image data to the display section 409. The display section 409 displays the image based on the input image signal. The information processing device 3 can transmit and receive data to and from the measuring device 2 by the communication interface 410.

### [Operation of Sample Analyzer]

The operation of the sample analyzer 1 according to the present embodiment will be described below.

### <Sample Analyzing Procedure>

First, the analyzing procedure of the sample will be described. The analyzing procedure of the sample differs by the measurement item (PT, APTT, etc.) of the sample. The measurement item of the sample is specified by a measurement order. In the sample analyzer 1, the measurement order can be registered by a user, and the measurement order can be accepted from a server device (not shown).

The user logs on to the sample analyzer 1 before starting the sample analysis. Specifically, the input section 408 of the information processing device 3 is operated to input the user name and the password to the information processing device 3. The CPU 401 of the information processing device 3 then executes a user authentication process, where the log on of the user is executed if the user authentication is successful. In this case, history information of the log on operation is registered in the operation history database DB201.

A sample rack 60 accommodating a plurality of sample containers 61 is set in a pre-analysis rack holding region of the transportation path 51 by the user. The sample rack 60 is moved backward in the pre-analysis rack holding region, and then moved leftward in the transportation region. In this case, a barcode label attached to the sample container 61 is read by a sample barcode reader 52. A sample ID is recorded on the barcode of the sample container 61, so that the information processing device 3 acquires the measurement order of the sample with the read sample ID as a key.

The sample rack 60 is then positioned at a predetermined location of the transportation region. After the aspiration of the sample is finished in the transportation region, the sample rack 60 is moved leftward in the transportation region, and then moved forward in the post-analysis rack holding region.

### Dispensing of Sample

The second catcher unit 27 sets the cuvette supplied to the cuvette port 34 in the cuvette holding hole 15a of the cuvette table 15. The first sample dispensing unit 21 aspirates the sample of the sample container 61 positioned at a predetermined sample aspirating position 53 of the transportation region of the transportation path 51. The sample aspirated by the first sample dispensing unit 21 is discharged to a cuvette set in the cuvette holding hole 15a positioned at a sample discharging position 18 on the forward position of the cuvette table 15. After the sample is discharged, a dispensing portion 21c of the first sample dispensing unit 21 is cleaned.

The first catcher unit 26 sets the cuvette supplied to the cuvette port 34 in the cuvette holding hole of the cuvette transport unit 32. The second sample dispensing unit 22 aspirates the sample accommodated in the cuvette at a sample aspirating position 19 or the sample of the sample container 61 positioned at a predetermined sample aspirating position 54 of the transportation region of the transportation path 51. The sample aspirated by the second sample dispensing unit 22 is discharged to the cuvette set in the cuvette transport unit 32. The second sample dispensing unit 22 can take in the diluted solution set in the diluted solution transport unit 33. In this case, the second sample dispensing unit 22 aspirates the sample at the sample aspirating position 19 or 54 after aspirating the diluted solution at a diluted solution aspirating position 37 before aspirating the sample.

When the measurement order including a plurality of measurement items is acquired for one sample, the sample is divided into small groups in the cuvette for the number of measurement items from the cuvette set in the cuvette holding hole 15a of the cuvette table 15 (secondary dispensing). Each cuvette corresponds to one measurement item, where the sample divided into small groups in the cuvette is measured for the measurement item corresponding to the relevant cuvette.

The cuvette transport unit 32 is driven rightward on the rail at a predetermined timing when the sample is discharged (secondary dispensing) to the accommodated cuvette. Then, the cuvette accommodating the sample set in the cuvette transport unit 32 is gripped by the first catcher unit 26, and set in the cuvette holding hole 16a of the warming table 16.

### Warming of Sample

The sample accommodated in the cuvette is warmed for a time corresponding to the measurement item at the warming table 16. For instance, the sample is warmed for three minutes if the measurement item is PT, and the sample is warmed for one minute if the measurement item is APTT.

After the sample is warmed, a trigger reagent is mixed to the sample. Depending on the measurement item, an intermediate reagent may be dispensed into the cuvette after the sample is warmed for a predetermined time, and a trigger reagent may be dispensed after the cuvette is again warmed for a predetermined time. If the measurement item is PT, for example, the PT reagent (trigger reagent) is dispensed into the cuvette accommodating the warmed sample, and thereafter, optical measurement is carried out in the detection unit 40.

In this case, the cuvette held in the cuvette holding hole 16a of the warming table 16 is gripped by the third catcher unit 28 and positioned at the reagent discharging position 39a or 39b. Here, the trigger reagent in a predetermined reagent container 200 arranged in the first reagent table 11 or the second reagent table 12 is aspirated and the trigger reagent is discharged at the reagent discharging position 39a or 39b by the second reagent dispensing unit 24 or the third reagent dispensing unit 25.

A case of again warming after the intermediate reagent is mixed in the warmed sample will now be described. For instance, if the measurement item is APTT, the APTT reagent (intermediate reagent) is dispensed into the cuvette accommodating the warmed sample, and then warmed again for two minutes at the warming table 16. Thereafter, calcium chloride solution (trigger reagent) is dispensed into the cuvette, and optical measurement is carried out in the detection unit 40. In the case of the measurement item in which the sample is warmed twice, the sample is warmed for a predetermined time at the warming table 16, and then the second catcher unit 27 grips the cuvette accommodating the sample set in the holding hole 16a and moves the same to the reagent discharging position 38. The first reagent dispensing unit 23 aspirates the intermediate reagent in the predetermined reagent container 200 arranged in the first reagent table 11 or the second reagent table 12, and discharges the intermediate reagent at the reagent discharging position 38. After the intermediate reagent is discharged in such manner, the second catcher unit 27 stirs the relevant cuvette, and again sets the cuvette in the cuvette holding hole 16a of the warming table.

The cuvette held in the cuvette holding hole 16a of the warming table 16 is gripped by the third catcher unit 28, and positioned at the reagent discharging position 39a or 39b. The second reagent dispensing unit 24 or the third reagent dispensing unit 25 aspirates the trigger reagent in a predetermined reagent container 200 arranged in the first reagent table 11 or the second reagent table 12, and discharges the trigger reagent at the reagent discharging position 39a or 39b.

### Light Measurement

After the trigger reagent is discharged in the above manner, the third catcher unit 28 sets the cuvette, to which the reagent is discharged, in the holding hole 41 of the detection unit 40. Thereafter, the optical information is detected from the measurement specimen accommodated in the cuvette in the detection unit 40.

The cuvette in which the optical measurement by the detection unit 40 is terminated and which is no longer necessary is moved to immediately above the discarding port 35 while being gripped by the third catcher unit 28, and discarded to the discarding port 35.

### Measurement Data Analysis

The optical information detected by the detection unit 40 is transmitted to the information processing device 3. The CPU 401 of the information processing device 3 applies the acquired optical information (measurement data) to the corresponding standard curve to obtain the analysis result (analysis value) of the sample. The analysis result obtained in such manner is stored in the analysis result database DB101 of the hard disc 404 in association with the sample information such as the sample ID, and output to the display section 409.

### <Recording of Event History>

In the sample analyzer 1 according to the present embodiment, the event history is recorded in the event history database (operation history database DB201, error history database DB202 and maintenance history database DB203) every time an event (operation of user, error, and maintenance) occurs. The recording of the event history will be hereinafter described using a plurality of examples.

The user logs on to the sample analyzer 1 before starting to use the sample analyzer. Specifically, the input section 408 of the information processing device 3 is operated to input the user name and the password to the information processing device 3. The CPU 401 of the information processing device 3 then executes a user authentication process, where the log on of the user is executed if the user authentication is successful. When such event occurs, the history information of the log on operation is registered in the operation history database DB201.

The user needs to replace the reagent when the reagent runs out or the expiration date of the reagent passes before starting the analysis or in the middle of the analysis. When executing the reagent replacement, the user uses the input section 408 of the information processing device 3 to specify the reagent to be replaced and instructs the replacement of the reagent. When accepting such instruction, the sample analyzer 1 executes an operation (reagent replacing operation) of moving the reagent to be replaced to a position where the user can replace the reagent. The user then takes out the old reagent from the sample analyzer 1, and installs a new reagent. When a new reagent is installed in the first reagent table 11 or the second reagent table 12 of the sample analyzer 1, the reagent information is read out by the barcode reader (not shown) from the barcode label attached to the reagent container, and the reagent information (type of reagent, lot number, remaining amount, expiration date, etc.) is registered in the reagent information database (not shown), and the replacement of the reagent is completed. When the reagent replacement is executed, the history information of the reagent replacement is registered in the operation history database DB201.

The standard curve is created for every lot of the reagent. In other words, the reagent replacement is carried out in the above manner and the lot of the reagent is changed between before and after the replacement, the standard curve for the new reagent needs to be created. The creation of the standard curve starts when the user uses the input section 408 of the information processing device 3 to give an instruction to create the standard curve to the sample analyzer 1.

The standard curve is created by measuring a standard substance (calibrator) for creating the standard curve with the sample analyzer 1. The measurement of the calibrator is carried out in a procedure similar to the analysis of the sample described above. As the concentration of the calibrator is known, a graph showing the relationship of the measurement value (optical information) and the concentration of the calibrator can be created. Such graph is registered in the standard curve database DB401 as the standard curve. When the creation of the standard curve is executed, the history information of creating the standard curve is registered in the operation history database DB201.

In the dispensing operation of the sample or the reagent, the pipette is lowered from above the reagent container or the cuvette, where when the liquid level sensor detects that the distal end of the pipette made contact with the liquid level, the pipette is lowered by a predetermined distance from such liquid level position and then the lowering of the pipette is stopped, so that the reagent or the sample is aspirated by the pipette. When the distal end of the pipette hits an obstacle (e.g., opening edge of reagent container or cuvette), the contact of the pipette with the obstacle is detected by the pipette abnormality sensor section 324 before the detection of the liquid level by the liquid level sensor. In this case, determination is made that the pipette abnormality (pipette crash) occurred. If the pipette abnormality is detected by the pipette abnormality detection sensor 324 during the execution of the sample analyzing operation, the sample analyzing operation is interrupted, and a message for occurrence of pipette abnormality is output to the display section 409. The history information related to the pipette abnormality is also registered in the error history database DB202.

When the pipette is used in the execution of the sample analysis, and the number of usages of the pipette exceeds a predetermined value, the pipette replacement error occurs. In this case, a message of occurrence of the pipette replacement error is output to the display section 409, and the history information related to the pipette replacement error is registered in the error history database DB202.

When the pipette needs to be replaced, the pipette is replaced by a service man or a user. When executing the pipette replacement, the service man or the user uses the input section 408 of the information processing device 3 to specify the pipette to be replaced, and instructs the replacement of the pipette. When receiving the instruction, the sample analyzer 1 executes the operation (pipette replacing operation) of moving the pipette to be replaced to a position where the user can replace the pipette. The user then takes out the old pipette from the sample analyzer 1, and installs a new pipette. When a new pipette is attached to the dispensing unit of the sample analyzer 1, the remaining number of usages of the pipette is reset, and the pipette replacement is completed. When the pipette replacement is executed, the history information of the pipette replacement is registered in the maintenance history database DB201.

The pipette is cleaned for every dispensing operation, but apart from such cleaning, the pipette may be subjected to a stronger cleaning. Such pipette cleaning is carried out by the service man or the user. When executing the pipette cleaning, the service man or the user uses the input section 408 of the information processing device 3 to instruct the start of the pipette cleaning operation. When receiving the instruction, the sample analyzer 1 executes the operation of cleaning the pipette with a cleaning liquid (not shown). When the pipette cleaning is executed, the history information of the pipette cleaning is registered in the maintenance history database DB201.

The accuracy management is executed at an appropriate timing, at least once a day, such as immediately after starting up the sample analyzer 1 at the beginning of the day (i.e., before start of sample analysis of the day). Such accuracy management is carried out by measuring the control by the sample analyzer 1. The accuracy management is started when the user uses the input section 408 of the information processing device 3 to give an instruction to start the measurement of the accuracy management to the sample analyzer 1.

The measurement of the accuracy management substance by the sample analyzer 1 is carried out through a procedure similar to the analysis of the sample described above. Whether the sample analyzer 1 is normal or abnormal is determined from whether or not the analysis value (accuracy management result) of the accuracy management substance is within a predetermined upper limit value and a lower limit value. When such accuracy management is executed, the history information of the accuracy management is registered in the operation history database DB201.

If the accuracy measurement result is not within a range between the predetermined upper limit value and the lower limit value, determination is made that the accuracy management abnormality occurred, and a message informing the occurrence of the accuracy management abnormality is output to the display section 409. The history information related to the accuracy management abnormality is also registered in the error history database DB202.

The event history is an example, and the event history is recorded even when various events other than the events described above occurred in the sample analyzer 1.

### <Uncertainty Cause Displaying Operation>

The sample analyzer 1 according to the first embodiment can output the cause of uncertainty regarding the analysis result of the sample analyzer 1. The uncertainty cause displaying operation is realized when the CPU 401 of the information processing device 3 executes an uncertainty cause displaying process described below.

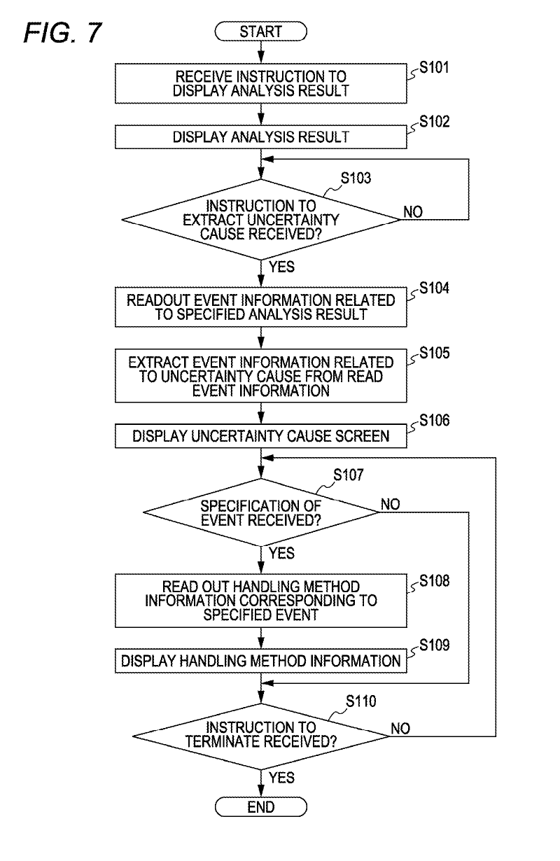

FIG. 7 is a flowchart showing a flow of an uncertainty cause displaying process by the information processing device 3 according to the present embodiment. The information processing device 3 has information of the past sample analysis result stored in the analysis result database DB 101. In such information processing device 3, the sample analysis result registered in the analysis result database DB101 can be displayed. When displaying the sample analysis result, the user needs to operate the input section 408 to instruct the display of the sample analysis result to the information processing device 3. When receiving the instruction to display the sample analysis result from the user (step S101), the CPU 401 reads out the analysis result registered in the analysis result database DB101, and displays the same on the display section 409 (step S102).

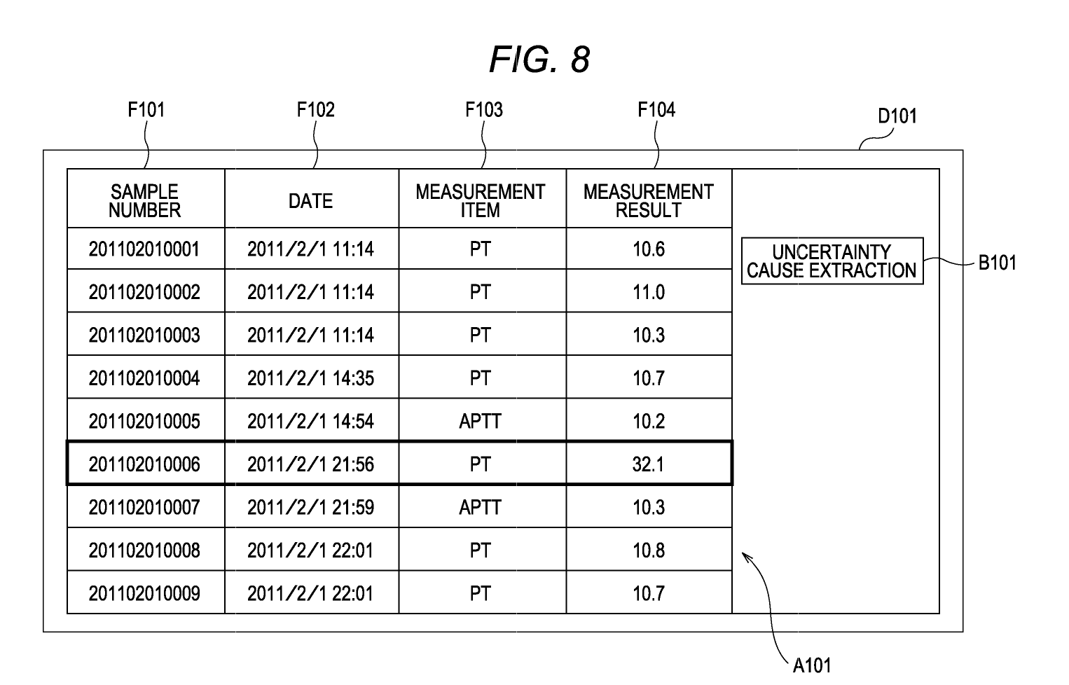

FIG. 8 is a view showing an example of an analysis result screen. The analysis result screen D101 includes an analysis result region A101, where a list of analysis result information is displayed in the analysis result region A101. The analysis result region A101 includes each display column F101, F102, F103, F104 for the sample number, the date and time of sample analysis, the analyzing item (measurement item), and the analysis result (measurement result). Each row of the analysis result region A101 corresponds to the analysis result, so that the user can select an arbitrary row by click operation with the mouse. A button B101 for extracting the uncertainty cause is arranged on the right side of the analysis result region A101. Such button B101 is a selectable control object.

In the analysis result screen D101 described above, the user can check the analysis result. Thus, the user can compare each analysis result and easily determine the characteristic analysis result by displaying the analysis results in a list. For instance, if a certain analysis result is significantly high or low compared to the other analysis results, such analysis result can be said as being characteristic. If a certain analysis result significantly differs from other analysis results, whether it accurately represents the aspect of the sample or it is due to the influence of uncertainty becomes an issue. That is, when the uncertainty of the sample analysis result is great, if the analysis result is significantly different from the other analysis results, this can be assumed as a result of influence by the cause of uncertainty. Therefore, it is important to reduce the influence of the cause of uncertainty on the analysis result as much as possible to enhance the reliability of the analysis result in the sample analyzer 1. Therefore, in the sample analyzer 1 according to the present embodiment, an arbitrary sample analysis result can be selected, and the cause of uncertainty associated with the selected sample analysis result can be displayed. The user can specify the analysis result, of which cause of uncertainty the user desires to know, and give an instruction to display the cause of uncertainty to the information processing device 3 to display the cause of uncertainty associated with the selected analysis result.

The CPU 401 receives the selection of one analysis result from the user, and further receives the selection of the button B101 to receive the instruction to extract the cause of uncertainty (step S103). The CPU 401 maintains the display of the analysis result screen D101 until receiving such input (NO in step S103). When receiving the instruction to extract the uncertainty cause in step S103 (YES in step S103), the CPU 401 reads out the event information associated with the specified analysis result fromthe operation history database DB201, the error history database DB202, and the maintenance history database DB203 (step S104).

The process of step S104 will be specifically described. The specified analysis result includes information of the analyzed date and time and the measurement item. In the process of step S104, whether or not the event information is associated with the analysis result is determined by criteria that differ depending on the type of event. When the operation is performed by the user, the influence of uncertainty by the operation appears in the analysis result obtained after the date and time at which the relevant operation is performed. Therefore, in step S104, the information of the operation performed before the analyzed date and time is acquired of the operation information recorded in the operation history database DB201 when the type of event is operation of the user. For instance, if the analyzed date and time is Feb. 1, 2011 at 11:00, the operation information generated before Feb. 1, 2011 at 11:00 is acquired. This is determined by the date and time information contained in the operation information recorded in the operation history database DB201.

If the same operation is performed two or more times, the operation performed immediately before may become the cause of uncertainty in the analysis result, but the operation performed two or more times before does not become the cause of uncertainty in the analysis result. Therefore, in step S104, only the operation information performed immediately before the analyzed date and time related to the specified analysis result of the two or more operation information related to the same operation recorded in the operation history database DB201 is acquired in principle, and the operation information before that is not acquired as a general rule.

The event information of the reagent replacement performed two or more times before may be acquired for the operation of reagent replacement. This is because a plurality of types of reagents exists. That is, the trigger reagent and the diluted solution are respectively accommodated in different reagent containers, and each reagent is independently replaced. The replacement of the trigger reagent may become the cause of uncertainty in the analysis result of the relevant measurement item. Similarly, the diluted solution is a reagent common to each measurement item, and may become the cause of uncertainty in the analysis result of all measurement items. Therefore, in step S104, the respective event information of the replacement of the trigger reagent and the replacement of the diluted solution immediately before the analysis result are both acquired. With respect to the measurement item that uses not only the trigger reagent but also the intermediate reagent, the replacement of the intermediate reagent may also become the cause of uncertainty in the analysis result of the relevant measurement item. Therefore, in step S104, if the analysis result related to the measurement item using the intermediate reagent is specified, the respective event information of the replacement of the trigger reagent, the replacement of the diluted solution, and the replacement of the intermediate reagent immediately before the analyzed date and time are all acquired.

When the maintenance is carried out by the service man or the user, the influence of uncertainty due to the maintenance task may appear in the analysis result obtained after the date and time at which the maintenance was performed. Therefore, in step S104, the information of the maintenance performed before the analyzed date and time of the maintenance information recorded in the maintenance history database DB203 is acquired if the type of event is maintenance. For instance, if the analyzed date and time is Feb. 1, 2011 at 11:00, the maintenance information generated before Feb. 1, 2011 at 11:00 is acquired. This is determined by the date and time information contained in the maintenance information recorded in the maintenance history database DB203.

If the same maintenance task is performed two or more times, the maintenance task performed immediately before may become the cause of uncertainty in the analysis result, but the maintenance task performed two or more times before does not become the cause of uncertainty in the analysis result. Therefore, in step S104, only the maintenance information performed immediately before the analyzed date and time related to the specified analysis result of the two or more maintenance information related to the same maintenance item recorded in the maintenance history database DB203 is acquired, and the maintenance information before that is not acquired.

With respect to errors, not only the error generated before the analysis result but also the error generated after the analysis result may become the cause of uncertainty depending on the item of error. For instance, the accuracy management is sometimes performed both before starting the sample analysis and after the termination of the sample analysis. In this case, if abnormality occurs in one of the accuracy management performed before the start of sample analysis or the accuracy management performed after the termination of sample analysis, the accuracy management error becomes the cause of uncertainty in the sample analysis performed between both accuracy managements. Therefore, in step S104, the accuracy management error immediately before the analyzed date and time or the accuracy management error immediately after the analyzed date and time related to the sample analysis result is acquired for the accuracy management error. This is determined by the date and time information contained in the error information recorded in the error history database DB202. Furthermore, the accuracy management error that occurred two or more times before the analyzed date and time is not acquired in step S104 as it does not become the cause of uncertainty.

Even if the accuracy management error occurs, the reliability of the analysis result of the sample analyzer 1 can be recovered if the accuracy management result becomes normal thereafter. That is, even if the accuracy management error occurs before the analyzed date and time, the accuracy management error does not become the cause of uncertainty in the analysis result if the accuracy management result obtained after the date and time at which the accuracy management error occurred and before the analyzed date and time is normal. Therefore, the accuracy management error is not acquired in step S104.

With regards to errors other than the accuracy management error such as the pipette crash, the influence of uncertainty due to error appears in the analysis result obtained after the date and time at which the error occurred. Therefore, in step S104, the information of the error that occurred before the analyzed date and time of the error information recorded in the error history database DB 202 is acquired if the type of event is error.

If the same error occurred two or more times, the error that occurred immediately before may become the cause of uncertainty in the analysis result, but the error that occurred two or more times before does not become the cause of uncertainty in the analysis result. Therefore, in step S104, only the error information that occurred immediately before the analyzed date and time related to the specified analysis result of the two or more error information related to the same error recorded in the error history database DB202 is acquired, and the error information before that is not acquired.

It is assumed that an event long time before the analyzed date and time does not become the cause of uncertainty with respect to the analysis result. Thus, in step S104, the event information of a predetermined period before the analyzed date and time is not acquired. The predetermined period is a value (e.g., one month) set in the sample analyzer 1 in advance.

The event information acquired in step S104 is the event information associated with the measurement item of the specified analysis result. The event includes an event associated with a specific measurement item and an event common to all the measurement items. For instance, the reagent replacement is an event associated with a specific measurement item since the reagent is arranged for every measurement item. The standard curve creation and the accuracy management are also events executed for a specific measurement item. Therefore, when the measurement item of the specified analysis result is “PT”, the event information of the reagent replacement of “PT”, the event information of the standard curve creation of “PT”, the event information related to the accuracy management of “PT”, and the like are acquired, and the event information related to other measurement items (e.g., “APTT”) is not acquired. The event common to all the measurement items includes pipette abnormality, pipette replacement error, pipette replacement, pipette cleaning, and the like, on the other hand.

After the process of step S104 is finished, the CPU 401 extracts the event information related to the cause of uncertainty from the acquired event information (step S105). This process will be specifically described below. The event information includes the event associated with the uncertainty cause and the event not associated with the uncertainty cause. The event associated with the uncertainty cause is registered in advance in the uncertainty cause database DB301. In step S105, the CPU 401 matches the type of event of the acquired event information (type of operation, type of error, or type of maintenance) with the type of event of the uncertainty cause registered in the uncertainty cause database DB301 and extracts only the event information associated with the matching uncertainty cause. Therefore, only the information of the event associated with the specified analysis result and associated with the uncertainty cause of the events that occurred in the past can be acquired.

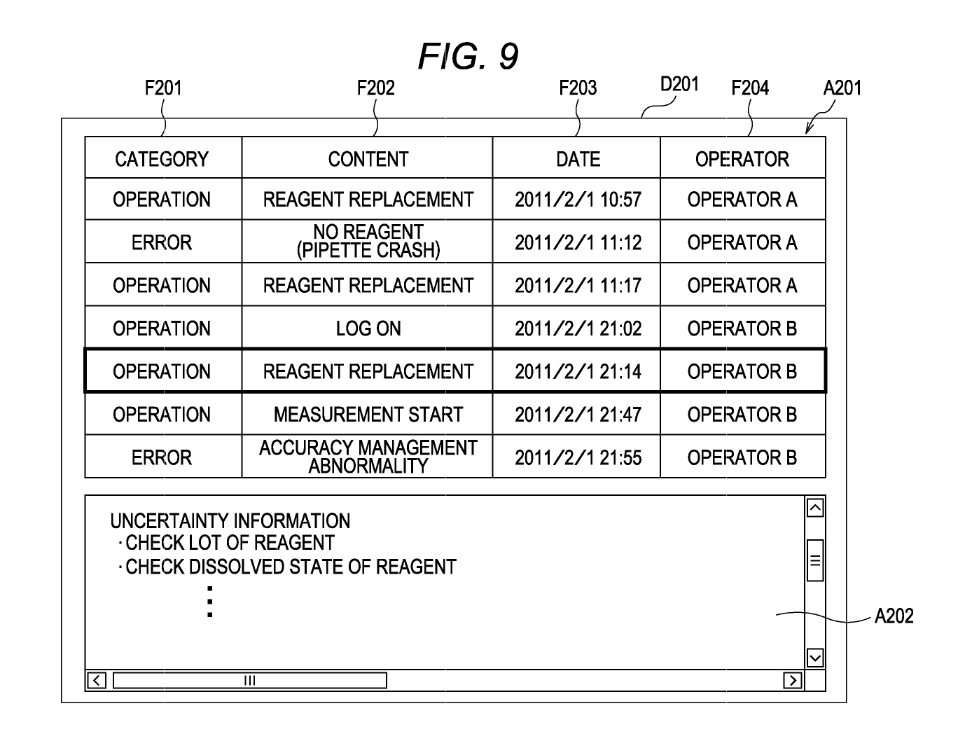

After the process of step S105 is finished, the CPU 401 displays the extracted uncertainty cause screen (step S106). FIG. 9 is a view showing one example of the uncertainty cause screen. As shown in FIG. 9, an uncertainty cause screen D201 includes an event information display region A201 and a handling method display region A202. The event information display region A201 displays a list of event information acquired in step S105. Such event information display region A201 includes a display column F201 of a category (operation, error, maintenance) of an event, a display column F202 of a content (type) of an event, a display column F203 of an occurred date and time of an event, and a display column F204 of a name of an operator, that is, a user who was logged on when the event occurred. Each row of the event information display region A201 corresponds to the event information, so that the user can select an arbitrary row by click operation with the mouse.

The CPU 401 determines whether or not a specification of one event information displayed in the event information display region A201 is received (step S107), and proceeds the process to step S110 if the specification of the event information is not received (NO in step S107). If the specification of the event information is received (YES in step S107), the CPU 401 reads out information (hereinafter referred to as “handling method information) of the handling method on the uncertainty corresponding to the specified event information from the uncertainty cause database DB301 (step S108), and displays the read handling method information in the handling method display region A202 of the uncertainty cause screen D201 (step S109).

The handling method information displayed in the handling method display region A202 shows the method for reducing the uncertainty related to the selected event. Therefore, the user can reduce the uncertainty that influences the sample analysis result by practicing the handling method displayed in the handling method display region A202. For instance, the user may specify the event information that is assumed to be strongly affecting the sample analysis result from the event information displayed in the event information display region A201 of the uncertainty cause screen D201, so that the handling method information for reducing the uncertainty associated with the event is displayed in the handling method display region A202. The user then can easily understand how to reduce the uncertainty.

When terminating the display of the uncertainty cause screen, the user operates the input section 408 to give an instruction to terminate the uncertainty cause displaying process to the information processing device 3. The CPU 401 determines whether or not the termination instruction is received (step S110), and returns the process to step S107 if the termination instruction is not received (NO in step S110). If the termination instruction is received in step S110 (YES in step S110), the CPU 401 terminates the process.

As described above, in the sample analyzer 1 according to the present embodiment, the event information related to the uncertainty cause is displayed in the uncertainty cause screen D201, so that the user can analyze what the cause of uncertainty is using the relevant event information. Furthermore, since the handling method information for reducing the uncertainty related to the specified event information is displayed in the uncertainty cause screen D201, the user can easily understand how to reduce the uncertainty. The user can reduce the uncertainty that influences the sample analysis result by practicing the handling method.

### Other Embodiments

In the embodiment described above, a configuration of displaying a list of past sample analysis results in the analysis result screen D101 has been described, but this is not the sole case. For instance, a button or an icon for calling out the uncertainty cause screen may be provided in the screen for displaying in detail only one sample analysis result, so that a display can be switched from the display screen of the sample analysis result to the uncertainty cause screen when the instruction to display the uncertainty cause screen is received by selecting the button or the icon.

In the present embodiment, the analysis result information including the information indicating abnormality is registered in the analysis result database DB101 when determination is made that the sample analysis result is abnormal. Thus, the analysis result determined as abnormal can be displayed on the analysis result screen so as to be distinguishable from the analysis result not determined as abnormal. The analysis result determined as abnormal has a possibility of being strongly affected by the uncertainty cause, and thus the event information related to the analysis result determined as abnormal can be easily checked in the uncertainty cause screen in such manner. The event information related to the analysis result determined as abnormal has a high possibility of including the cause of uncertainty that strongly influences the sample analysis result, and thus the user can appropriately carry out the analysis of the uncertainty cause in such manner.

In the embodiment described above, the handling method information to be stored in the uncertainty cause database DB301 is displayed in the handling method display region A202 of the uncertainty cause screen D201, but a configuration enabling the setting of the priority of the handling method, that is, the order of effectively reducing the uncertainty can be adopted.

In the embodiment described above, a configuration in which the event information related to the uncertainty cause and the handling method information for reducing the uncertainty are displayed in the uncertainty cause screen D201 has been described, but this is not the sole case. For instance, the event information related to the uncertainty cause may be displayed, and the handling method information may not be displayed. Furthermore, a configuration in which the handling method information related to the selected event is displayed when one of the event information being displayed is selected has been described, but this is not the sole case. The related handling method information may be displayed for all the event information being displayed. Furthermore, the event information related to the uncertainty cause may not be displayed, and the handling method information corresponding to the event information related to the specified analysis result may be displayed.

In the embodiment described above, a configuration in which a plurality of analysis results is displayed on the analysis result screen, and the event information related to the selected analysis result is displayed in the uncertainty cause screen D201 when one of the analysis results being displayed is selected has been described, but this is not the sole case. For instance, the specification of the analysis result may be received by receiving an input from the user of a search key such as a sample number, a patient name, or the like, the sample analysis result including the input search key may be searched from the analysis result database, and at least one of the event information or the handling method information related to the searched analysis result may be displayed.

In the embodiment described above, the sample analyzer 1 is a blood coagulation measurement device, but is not limited thereto. The sample analyzer may be a sample analyzer other than the blood coagulation measurement device such as a blood cell counting device, an immune analyzer, a urine sediment analyzer, or a urine qualitative analyzer, and the event information of the cause of uncertainty of such sample analyzer may be displayed by the information processing device 3.

What is claimed is:

1. A sample analyzer, comprising:
an analyzing section for analyzing a sample;
a memory for storing analysis results of the sample by the analyzing section and an event history information indicating an event that occurred in the sample analyzer;
an input device used to specify an analysis result from a plurality of analysis results stored in the memory;
a display; and
a controller for acquiring an event history information related to the analysis result specified by the input device from the memory and controlling the display to show information related to a cause of uncertainty of the specified analysis result based on the acquired event history information.

2. The sample analyzer of claim 1, wherein
the controller is configured to control the display to show, as the information related to the cause of uncertainty, an event history information indicating an event causing the uncertainty of the specified analysis result.

3. The sample analyzer of claim 2, wherein
the selects the event history information indicating event, the event history information related to the analysis result specified by the input, and the display to selected event history information.

4. The sample analyzer of claim 3, wherein
the memory stores an event type information indicating a type of an event causing uncertainty of an analysis result, and
the controller selects the event history information indicating the event causing the uncertainty of the specified analysis result, based on the event type information stored in the memory.

5. The sample analyzer of claim 2, wherein
the controller is configured to control the display to show, as the information related to the cause of uncertainty, a plurality of event history information, each indicating an event causing uncertainty of the specified analysis result;
the input device is used to specify an event history information from the plurality of event history information shown on the display; and
the controller controls the display to show an action information indicating an action to reduce uncertainty caused by an event indicated by the event history information specified by the input device.

6. The sample analyzer of claim 5, wherein
the memory stores an action information indicating an action for reducing uncertainty for every cause of uncertainty; and
the controller acquires, from the memory, an action information corresponding to the event history information specified by the input device and controls the display to show the acquired action information.

7. The sample analyzer of claim 1, wherein
the memory stores an action information indicating an action for reducing uncertainty related to an event; and
the controller acquires, from the memory, an action information indicating an action for reducing the uncertainty related to the acquired event history information and controls the display to show the acquired action information as the information related to the cause of uncertainty.

8. The sample analyzer of claim 1, wherein
the event includes at least one of manual operation in the sample analyzer, an error occurred in the sample analyzer, and maintenance executed in the sample analyzer.

9. The sample analyzer of claim 2, further comprising
a reagent container holder for holding a plurality of reagent containers, each containing a reagent used for analyzing a sample, wherein
the memory stores an operation history information indicating a history of reagent replacement in the reagent container holder as the event history information; and
the controller controls the display to show, as the event history information, an operation history information indicating a replacement history of a reagent used to obtain the analysis result specified by the input device.

10. The sample analyzer of claim 2, wherein
the memory stores information indicating a standard curve used for an analysis of an sample and stores an operation history information indicating a creation history of the standard curve as the event history information; and
the controller controls the display to show as the event history information an operation history information indicating a creation history of a standard curve used to obtain the analysis result specified by the input device.

11. The sample analyzer of claim 2, wherein
the memory is configured to store an error history information indicating an abnormality of quality control as the event history information when an analysis result obtained by analyzing a quality control substance is abnormal; and
the controller controls the display to show, as the event history information, an error history information indicating an abnormality of quality control related to the analysis result specified by the input device.

12. The sample analyzer of claim 2, further comprising
a dispensing unit equipped with an aspirating tube for aspirating a sample or a reagent; wherein
the memory stores a maintenance history information indicating a replacement history of the aspirating tube of the dispensing unit as the event history information, and
the controller controls the display to show, as the event history information, a maintenance history information indicating a replacement history of the aspirating tube related to the analysis result specified by the input device.

13. The sample analyzer of claim 2, wherein
if a same type of event history information is stored in plurals in the memory, the controller extracts an event history information that conforms with a predetermined extracting condition from the plurality of event history information of the same type stored in the memory, and controls the display to show the extracted event history information.

14. The sample analyzer of claim 13, wherein
the extracting condition is provided for every type of event.

15. The sample analyzer of claim 13, wherein
the analyzing section is capable of analyzing a sample for a plurality of analyzing items, and
the controller extracts the event history information related to an analyzing item of the analysis result specified by the input device.

16. The sample analyzer of claim 1, wherein
the memory includes an analysis result database storing the analysis result of the sample by the analyzing section, and an event history database storing the event history information indicating the event that occurred in the sample analyzer.

17. A non-transitory storage medium which stores computer-executable programs executed by at least one processor of a sample analyzer to:
store an analysis result obtained by the sample analyzer in a memory;
store an event history information indicating an event that occurred in the sample analyzer in the memory;
acquire from the memory an event history information related to an analysis result specified by an input device of the analysis results from a plurality of analysis results stored in the memory and control a display to show information related to a cause of uncertainty of the specified analysis result based on the acquired event history information.

18. A sample analyzer, comprising:
an analyzing section for analyzing a sample;
an input device used to specify an analysis result from a plurality of analysis results obtained by the analyzing section;
a display; and
a controller connected to a memory, wherein
the memory stores an analysis result of the sample by the analyzing section and stores an event history information indicating an event that occurred in the sample analyzer; and
the controller acquires from the memory an event history information related to the analysis result specified by the input device and controls the display to show information related to a cause of uncertainty of the analysis result based on the acquired event history information.

19. The sample analyzer of claim 18, wherein
the controller controls the display to show an event history information indicating an event causing uncertainty of the specified analysis result, as the information related to the cause of uncertainty.

20. The sample analyzer of claim 18, wherein
the controller selects the causing uncertainty of event information from the event history information related to the analysis result specified by the input device, and controls the display to show the selected event information.
